(19) United States
(12) Patent Application Publication
(10) Pub. No.: US 2008/0053572 A1
(43) Pub. Date: Mar. 6, 2008

(54) Soldering flux and solder paste composition

(75) Inventors: Masaki Sanji, Kariya-shi (JP); Masayasu Yamamoto, Kariya-shi (JP); Kensuke Nakanishi, Kakogawa-shi (JP); Masami Aihara, Kakogawa-shi (JP)

Correspondence Address: SUGHRUE MION, PLLC, 2100 PENNSYLVANIA AVENUE, N.W., SUITE 800, WASHINGTON, DC, 20037, US

(73) Assignees: DENSO CORPORATION, Kariya-shi (JP); Harima Chemicals, Inc., Kakogawa-shi (JP)

(21) Appl. No.: 11/896,691

(22) Filed: Sep. 5, 2007

(30) Foreign Application Priority Data
Sep. 5, 2006 (JP) 2006-240228

(51) Int. Cl. B23K 35/363

(52) U.S. Cl. 148/23

(57) ABSTRACT

A soldering flux contains a base resin and an activating agent. The base resin contains a thermoplastic acrylic resin having a glass transition temperature of below −50° C. This enables to sufficiently suppress the occurrence of cracks in the flux residue after soldering, under the severe environment where the temperature difference is extremely large. The soldering flux has high reliability and excellent solderability, and is conventional with respect to the load against manufacturing cost and environment.

### BACKGROUND OF THE INVENTION

1. Field of the Invention

The present invention relates to a soldering flux and a solder paste composition which are used, for example, in a solder connection of circuit components to a circuit board.

2. Description of Related Art

In the solder connection of electronic circuit components, various types of soldering fluxes and solder paste compositions have conventionally been used. Especially, the fluxes are essential to excellent soldering, which eliminate metal oxide on solder and the board surface, and prevents the re-oxidation of metal during the soldering, thus lowering the surface tension of the solder. Although the flux residue was conventionally removed by washing after soldering, recently, the flux residue is left as a protective film of a soldering portion without washing.

However, the conventional fluxes and the solder paste compositions have suffered from a problem that cracks occur in the flux residue after soldering, and moisture enters into these cracks, causing defects on short-circuit between component leads. There is a high probability that this problem will especially occur on circuit boards to be mounted on vehicles subjected to a large difference in temperature in use, and large vibrations.

As a method of remedying this problem, the following means for preventing cracks have been proposed thus far. That is, there are means a) where plasticizer having a high boiling point is added to allow the plasticizer to remain in the residue after soldering, as in the method where the ester of trimellitic acid as plasticizer having a high boiling point is added to a soldering paste using rosin as a base resin (refer to Japanese Unexamined Patent Application Publication No. 9-234588); means b) where like the copolymer of ethylene or propylene, a synthetic resin designed to have flexibility is used as a base resin, such as a soldering flux using ethylene acrylic copolymer (refer to Japanese Unexamined Patent Application Publication No. 9-122975), and a soldering flux using acrylic resin having a glass transition temperature in the range of −50° C. to −35° C. (refer to Japanese Unexamined Patent Application Publication No. 13-150184); and means c) where after soldering, cleaning is performed to remove flux residue.

However, the abovementioned means a) has the problem that the occurrence of cracks in flux residue can be reduced, whereas reliability may be lowered because liquid substance remains.

The abovementioned means c) has the problems that a post processing for cleaning and the extension of cleaning facility are needed, thus increasing the product costs, and that the solvent used for cleaning may cause environmental pollution.

The abovementioned means b) has the problem that the use of the synthetic resin makes it difficult to ensure solder wettability, resulting in lower solderability than rosin type flux.

In the publication No. 13-150184 disclosing the abovementioned means b), it is further reported that it was able to suppress cracking of the flux residue after exerting 1000 cycles of cold and hot impact ranging from −30° C. to 80° C. By the method of this publication, excellent soldering has been carried out under environment as in the room of a vehicle where in spite of the difference of temperature, it is relatively calm in on-vehicle environment (about 70° C. to 80° C. in the difference of temperature). However, as the number of on-vehicle boards has recently been increased, the number of arrangements of packaging boards under severer environment where violent vibration is exerted in the atmosphere of a wide temperature difference (nearly 120° C. or above), for example, in the vicinity of the engine within an engine room. Hence, the method of the publication No. 13-150184 suffers from the problem that it is difficult to exhibit satisfactory the effect of suppressing cracks under these severer environments.

Although neither flux nor soldering paste, which can exhibit satisfactory performances (ensuring reliability, the capability of preventing cracks, and the like) under the severe environment where the difference in temperature is extremely large, and the vibration is exerted, is not yet developed at the present state, it can be expected that demand therefor will be further increased.

### SUMMARY OF THE INVENTION

A main advantage of the present invention is to provide a soldering flux and a solder paste composition, which can sufficiently suppress the occurrence of cracks in flux residue after soldering, and have high reliability and excellent solderability under severe environment where the difference of temperature is extremely large. In the soldering flux and the solder paste composition, the load against manufacturing cost and environment are the same as conventional.

The present inventors have made tremendous research effort to solve the abovementioned problems. As the result, they have found the following fact that even when placing a load of severe low and high temperature cycles, for example, ranging from −40° C. to 125° C., the cracks of flux residue can be suppressed effectively by using thermoplastic acrylic resin having a glass transition temperature of below a specific temperature, as a base resin of soldering flux.

Specifically, a soldering flux of the present invention comprises a base resin and an activating agent. The soldering flux contains, as the base resin, a thermoplastic acrylic resin having a glass transition temperature of below −50° C.

A solder paste composition of the present invention comprising the soldering flux of the present invention and the solder alloy powder.

In accordance with the present invention, even under environment where there are large vibration and a large temperature difference, and low and high temperature cycles occur frequently, such as the engine room of a vehicle in winter or a cold district, the occurrence of cracks of flux residue after soldering can be sufficiently suppressed, and high reliability and excellent solderability can be obtained. This prevents ionization of the remaining activating agent to be caused by the entrance of moisture, thereby avoiding poor electric insulation and the occurrence of corrosion. Thus, the present invention is capable of preventing, irrespective of use environment, short circuit due to the cracks of flux residue, connecting parts missing due to insufficient soldering, and breaking of wire due to corrosion. It is therefore possible to obtain the effect of enabling an easy manufacture of electronic equipment with high reliability and high quality. Additionally, since the present invention does not require the cleaning of residual flux after soldering, as has been conventional, there is no likelihood that the manufacturing cost becomes expensive, and there is no likelihood that the cleaning solvent has any adverse effect upon the human body and the environment.

Other objects and advantages of the present invention will become more apparent from the following detailed description of the present invention.

### DESCRIPTION OF PREFERRED EMBODIMENTS

A preferred embodiment of the present invention is described below in detail.

A soldering flux of the present invention (hereinafter, in some cases, referred to simply as “flux”) contains, as a base resin, a thermoplastic acrylic resin having a glass transition temperature of below −50° C. (hereinafter, in some cases, referred to as “low Tg acrylic resin”). The low Tg acrylic resin has extremely high flexibility, and excellent cracking resistance and peeling resistance. Therefore, even when placing a load of severe low and high temperature cycles ranging from −40° C. to 125° C., excellent solderability and high reliability can be achieved, while effectively suppressing the occurrence of cracks in the flux residue after soldering. If the glass transition temperature is above −50° C., the effect of the present invention, that is, the suppression of occurrence of cracks in the residue, will be insufficient when placing a load of severe low and high temperature cycles, such as from −40° C. to 125° C.

In the present invention, the glass transition temperature (Tg) is calculated from the following formula by using the Tg of various types of homopolymers.

$$1 / Tg = {\sum }_{i = 1}^{n} ( W i / Tg i )$$

where Tg is a Tg (K) of a copolymer; Tgi is a Tg (K) of the homopolymer which consists of each monomer which constitutes the copolymer; and Wi is a rate of a weight part of each monomer which constitutes the copolymer.

Preferably, the low Tg acrylic resin has an acid value of 50 mg KOH/g or more. This further enhances activation function. Preferably, the low Tg acrylic resin has a weight average molecular weight of not more than 10,000. This is because a low viscosity of the flux at the time of soldering tends to increase solder wettability.

The abovementioned low Tg acrylic resin is, for example, a homopolymer or a copolymer which can be obtained by polymerizing one or more types of monomers having the polymerized unsaturated group. Examples of the monomer having the polymerized unsaturated group are (meth)acrylic acid and various esters thereof, crotonic acid, itaconic acid, maleic acid or maleic anhydride and various esters thereof, (meth)acrylonitril, (meth)acrylamide, vinyl chloride, and vinyl acetate, without limitation. Hereinafter, “(meth)acrylic” means “acrylic” or “methacrylic”, and “(meth)acryl” means “acryl” or “methacryl”. The polymerization of these monomers may be performed with catalyst, such as peroxide, by using a radical polymerization such as bulk polymerization method, solution polymerization method, suspension polymerization method, or emulsion polymerization method.

The content of the low Tg acrylic resin is preferably 0.5 to 80% by weight, more preferably 2 to 60% by weight, to the total amount of flux. If the low Tg acrylic resin is below 0.5% by weight, it is difficult to uniformly apply the activating agent to metal during the time of soldering. As a result, there is a likelihood that poor soldering will occur, and since the coating properties after soldering will be lowered, a high temperature durability tends to deteriorate. On the other hand, if the low Tg acrylic resin exceeds 80% by weight, there is a likelihood that the viscosity of the flux itself will be increased, so that the solderability tends to fall by becoming thick flux film.

The soldering flux of the present invention can further contain, as a base resin, rosin and its derivative used in flux conventionally and generally, or a thermoplastic acrylic resin having a glass transition temperature of −50° C. or above, as needed. In this case, these are preferably contained in such a range as to ensure a sufficient proportion in the base resin of the abovementioned low Tg acrylic resin (preferably, in the range that the low Tg acrylic resin is 60% by weight or above to the total amount of the base resin). Particularly, since rosin and its derivative function as a binder for uniformly applying the activating agent to the metal, it is desirable that at least one selected from the group consisting of rosin and its derivative is contained as a base resin.

Examples of the rosin and its derivative used in flux conventionally and generally are usual gum rosin, tall oil rosin, and wood rosin. As their derivatives, there are heat-treated resin, polymerized rosin, acrylated rosin, hydrogenated rosin, formylated rosin, rosin ester, rosin modified maleic acid resin, rosin modified phenol resin, and rosin modified alkyd resin.

A soldering flux of the present invention also contains an activating agent, together with the abovementioned base resin. The activating agent removes the oxide film on the metal surface during the time of soldering, thus ensuring excellent solderability.

Examples of the activating agent include halogenated hydracid salts of ethylamine, propylamine, diethylamine, triethylamine, ethylenediamine, and aniline or the like; and organic carboxylic acids such as lactic acid, citric acid, stearic acid, adipic acid, and diphenyl acetic acid.

The content of the activating agent is preferably 0.1 to 20% by weight to the total amount of flux. If the activating agent is below 0.1% by weight, there is a likelihood that insufficient activity lowers solderability. On the other hand, if the activating agent exceeds 20% by weight, there is a likelihood that the film-forming property of the flux is lowered, and hydrophilic property is increased, so that corrosion property and the insulation property tend to fall.

A soldering flux of the present invention also contains a thixotropic agent as needed, in addition to the base resin and the activating agent as described above. When the flux is used in the liquid state thereof, a suitable organic solvent may also be contained.

Examples of the thixotropic agent include cured castor oil, bees wax, carnauba wax, stearic acid amide, and hydroxy stearic acid ethylene bisamide. The content of the thixotropic agent is preferably 0.5 to 25% by weight to the total amount of the flux.

Preferred organic solvent is a polar solvent that is a solution obtained by dissolving the composition such as the low Tg acrylic resin, the activating agent and rosin. Usually, alcohol based solvents such as ethyl alcohol, isopropyl alcohol, ethyl cellosolve, butyl carbitol are preferably used. Alternatively, ester based solvents such as ethyl acetate and butyl acetate; or hydrocarbon based solvents such as toluene and turpentine oil may be used as an organic solvent. Among others, isopropyl alcohol is preferred from the viewpoints of volatility and the solubility of the activating agent.

The content of the organic solvent is preferably 20 to 99% by weight to the total amount of the flux. If the organic solvent is below 20% by weight, the viscosity of the flux might be increased, so that the coating property of the flux tends to deteriorate. On the other hand, if the organic solvent exceeds 99% by weight, the effective component (acrylic resin or the like) as flux might be relatively reduced, so that solderability might be lowered.

In addition to the abovementioned respective components, the flux of the present invention can also contain, in such a range as not to impair the effect of the present invention, a well known synthetic resin generally used as a base resin of flux (such as styrene-maleic acid resin, epoxy resin, urethane resin, polyester resin, phenoxy resin, or terpene resin), and additives such as oxidation inhibitor, antifungal agent, and matting agent.

A solder paste composition of the present invention contains the abovementioned soldering flux of the present invention and the solder alloy powder.

No special limitations are imposed on the solder alloy powder. For example, tin-lead alloy of general use, or tin-lead alloy further containing silver, bismuth, or indium may be used. Alternatively, lead-free alloys such as tin-silver based, tin-copper based, or tin-silver-copper based one may be used. The particle size of the solder alloy powder is preferably about 5 to 50 μm.

The weight ratio of the flux and the solder alloy powder in the solder paste composition of the present invention, namely, flux:solder alloy powder, is preferably approximately 5:95 to 20:80, without special limitations.

The solder paste composition of the present invention is applied onto a board by a dispenser, screen printing or the like, in the solder connection of electronic equipment parts and the like. After the application, preheating is carried out at, for example, about 150 to 200° C., followed by reflow at about a maximum temperature of 170 to 250° C. The application and the reflow with respect to the board may be performed in the atmosphere, or alternatively an inactive atmosphere of the gas such as nitrogen, argon, or helium.

### EXAMPLES

The present invention will be described below in further detail with reference to Examples and Comparative Examples. In the following description, the average molecular weights of acrylic resins shown in the respective manufacturing examples and tables are expressed by weight average molecular weight (Mw).

The evaluations of fluxes and solder paste compositions obtained by Examples and Comparative Examples were made by the following methods.

### [Solderability Test]

Flux was applied to a glass epoxy board with 15 pieces of SOP (shrink outline package) patterns of 0.8 mm pitch having 20 leads. The board after applying the flux was soldered by a wave soldering machine, in which solder alloy powder composed of Sn—Ag—Cu alloy (Sn:Ag:Cu=96.5:3.0:0.5 (weight ratio)) was used. Then, it was judged by visual observation whether the SOP pattern part had bridge defects. If so, the number of occurrences of the defects was counted to find a percentage of defects (%), expressing by percentage the ratio of the number of occurrences of the defects to the total number of the SOP patterns (300 pieces).

### [Solder Ball Test]

A solder paste composition was printed on a board having a QFP (quad flat package) pattern of 0.8 mm pitch by using a 200 μm thick metal mask having the same pattern. Within 10 minutes after the printing, preheating was performed at 175±5° C. for 80±5 seconds in the atmosphere, followed by reflow at a maximum temperature of 235±5° C. With regard to the state of occurrence of solder balls serving as an index of solderability, the number of solder balls occurred in the periphery of 80 pads (80 pieces of soldering portions) was counted by using a stereoscopic microscope of 20 times.

### [Crack Test]

Using, as a test piece, the board after subjected to the abovementioned solderability test or the solder ball test, a cold and hot cycle load was exerted on the test piece under the condition of 1000 cycles, each cycle ranging from −40° C. for 30 minutes to 125° C. for 30 minutes. The state of occurrence of cracks at the soldering portions of the SOP pattern or the QFP pattern on the board was visually observed and evaluated according to the following criteria.

Symbol “∘” represents that no crack was observed;

Symbol “Δ” represents that although cracks occurred, any crack adversely affecting reliability, namely cracks bridging two or more adjacent soldering portions (hereinafter referred to as “connecting cracks”) were not observed; and

Symbol “x” represents the occurrence of connecting cracks.

### [Insulation Resistance Test]

1) Flux: Flux was applied to a comb type board (II type) as defined in JIS-Z-3197. After applying the flux, soldering was performed by a wave soldering machine, in which solder alloy powder composed of Sn—Ag—Cu alloy (Sn:Ag:Cu=96.5:3.0:0.5 (weight ratio)) was used. Under the same condition as the abovementioned residual crack test, a cold and hot cycle load was exerted on the board after the soldering, and this board was then left in a thermo-hygrostat having a temperature of 85° C. and a humidity of 85%, and the resistance value (Ω) was measured with time (beginning, after 500 hours, and after 1000 hours) to evaluate an insulation resistance as electrical reliability.

2) Solder Paste Composition: A solder paste composition was printed on a comb type board (II type) as defined in JIS-Z-3197 by using a 100 μm thick metal mask having the same pattern. Within 10 minutes after the printing, preheating was performed at 175±5° C. for 80±5 seconds in the atmosphere, followed by reflow at a maximum temperature of 235±5° C. Under the same condition as the abovementioned residual crack test, a cold and hot cycle load was exerted on the board after the reflow. This board was then left in a thermo-hygrostat having a temperature of 85° C. and a humidity of 85%, and the resistance value (Ω) was measured with time (beginning, after 500 hours, and after 1000 hours) to evaluate an insulation resistance as electrical reliability.

### [Corrosion Test]

Copper plate corrosion test pieces as defined in JIS-Z-3197 were prepared by using flux or a solder paste composition. Under the same condition as the abovementioned residual crack test, a cold and hot cycle load was exerted on the test piece. Each of the test pieces was then left in a thermo-hygrostat having a temperature of 40° C. and a humidity of 85%. After 500 hours and after 1000 hours, it was confirmed by visual observation whether pitting corrosion or corrosion occurred.

### Manufacturing Example 1

A monomer composition composed of 40 weight parts of isooctyl acrylate, 35 weight parts of lauryl methacrylate, 10 weight parts of butyl acrylate, and 15 weight parts of methacrylic acid was polymerized by solution polymerization method, thereby obtaining a thermoplastic acrylic resin A.

The thermoplastic acrylic resin A had a glass transition temperature (Tg) of −55° C., an acid value of 100 mg KOH/g, and an average molecular weight of about 7000.

### Manufacturing Example 2

A monomer composition composed of 50 weight parts of 2-ethylhexyl acrylate, 37 weight parts of butyl acrylate, and 13 weight parts of acrylic acid was polymerized by solution polymerization method, thereby obtaining a thermoplastic acrylic resin B.

The thermoplastic acrylic resin B had a glass transition temperature (Tg) of −60° C., an acid value of 100 mg KOH/g, and an average molecular weight of about 6000.

### Manufacturing Example 3

A monomer composition composed of 75 weight parts of isooctyl acrylate, 17 weight parts of butyl acrylate, and 8 weight parts of methacrylic acid was polymerized by solution polymerization method, thereby obtaining a thermoplastic acrylic resin C.

The thermoplastic acrylic resin C had a glass transition temperature (Tg) of −70° C., an acid value of 50 mg KOH/g, and an average molecular weight of about 8000.

### Manufacturing Example 4

A monomer composition composed of 57 weight parts of isooctyl acrylate, 32 weight parts of ethyl acrylate, and 11 weight parts of acrylic acid was polymerized by solution polymerization method, thereby obtaining a thermoplastic acrylic resin D.

The thermoplastic acrylic resin D had a glass transition temperature (Tg) of −54° C., an acid value of 85 mg KOH/g, and an average molecular weight of about 5000.

### Manufacturing Example 5

A monomer composition composed of 50 weight parts of 2-ethylhexyl acrylate, 40 weight parts of isostearyl acrylate, and 10 weight parts of methacrylic acid was polymerized by solution polymerization method, thereby obtaining a thermoplastic acrylic resin E.

The thermoplastic acrylic resin E had a glass transition temperature (Tg) of −46° C., an acid value of 100 mg KOH/g, and an average molecular weight of about 7500.

### Manufacturing Example 6

A monomer composition composed of 56 weight parts of isooctyl acrylate, 39 weight parts of n-butylmethacrylate, and 5 weight parts of acrylic acid was polymerized by solution polymerization method, thereby obtaining a thermoplastic acrylic resin F.

The thermoplastic acrylic resin F had a glass transition temperature (Tg) of −46° C., an acid value of 54 mg KOH/g, and an average molecular weight of about 8500.

### Examples 1 to 4, and Comparative Examples 1 and 2

At least one of the acrylic resins A, B and E, which were obtained in the abovementioned manufacturing examples, and formylated rosin, as a base resin; adipic acid and aniline hydrobromide as activating agents; and isopropyl alcohol or butyl carbitol as a solvent, were mixed in the blending composition shown in Table 1-1 and Table 1-2, and then dissolved and dispersed by uniformly and sufficiently applying heat, thereby obtaining individual fluxes.

The obtained respective fluxes were used to make solderability test, crack test, insulation resistance test and corrosion test. The results are shown in Table 1-1 and Table 1-2.

TABLE 1-1

| | | Example | | | |
|---|---|---|---|---|---|
| | | 1 | 2 | 3 | 4 |
| Flux | Acrylic resin A | 8.7 | 5.7 | — | — |
| composition | Tg: −55° C. | | | | |
| (% by weight) | Acid | | | | |
| | value: 100 mgKOH/g | | | | |
| | Mw: about 7000 | | | | |
| | Acrylic resin B | — | — | 2.5 | 56.0 |
| | Tg: −60° C. | | | | |
| | Acid | | | | |
| | value: 100 mgKOH/g | | | | |
| | Mw: about 6000 | | | | |
| | Acrylic resin E | — | — | — | — |
| | Tg: −46° C. | | | | |
| | Acid | | | | |
| | value: 100 mgKOH/g | | | | |
| | Mw: about 7500 | | | | |
| | Formylated rosin | — | 3.0 | — | 15.0 |
| | Adipic acid | 1.0 | 1.0 | 0.5 | 1.0 |
| | Aniline hydrobromide | 0.3 | 0.3 | 0.1 | 0.3 |
| | Isopropyl alcohol | 90.0 | 90.0 | 96.9 | — |
| | Butyl carbitol | — | — | — | 27.7 |
| Solderability Test | | 1 or less | 1 or less | 1 or less | 1 or less |
| (Percentage of defects (%)) | | | | | |
| Crack Test | | ◯ | ◯ | ◯ | ◯ |
| Insulation | Beginning | 5 × 10¹² | 8 × 10¹² | 5 × 10¹² | 6 × 10¹² |
| Resistance | After 500 hours | 2 × 10¹⁰ | 1 × 10¹⁰ | 9 × 10⁹ | 2 × 10¹⁰ |
| Test | After 1000 hours | 2 × 10¹⁰ | 1 × 10¹⁰ | 8 × 10⁹ | 3 × 10¹⁰ |
| (Ω) | | | | | |
| Corrosion | After 500 hours | No | No | No | No |
| Test | | corrosion | corrosion | corrosion | corrosion |
| | After 1000 hours | No | No | No | No |
| | | corrosion | corrosion | corrosion | corrosion |

TABLE 1-2

| | | Comparative Example | |
|---|---|---|---|
| | | 1 | 2 |
| Flux | Acrylic resin A | — | — |
| composition | Tg: −55° C. | | |
| (% by weight) | Acid | | |
| | value: 100 mgKOH/g | | |
| | Mw: about 7000 | | |
| | Acrylic resin B | — | — |
| | Tg: −60° C. | | |
| | Acid | | |
| | value: 100 mgKOH/g | | |
| | Mw: about 6000 | | |
| | Acrylic resin E | — | 8.7 |
| | Tg: −46° C. | | |
| | Acid | | |
| | value: 100 mgKOH/g | | |
| | Mw: about 7500 | | |
| | Formylated rosin | 8.7 | — |
| | Adipic acid | 1.0 | 1.0 |
| | Aniline | 0.3 | 0.3 |
| | hydrobromide | | |
| | Isopropyl alcohol | 90.0 | 90.0 |
| | Butyl carbitol | — | — |
| Solderability Test | | 1 or less | 1 or less |
| (Percentage of defects (%)) | | | |
| Crack Test | | X | Δ |
| Insulation | Beginning | 5 × 10¹² | 6 × 10¹² |
| Resistance Test | After 500 hours | 6 × 10⁸ | 5 × 10⁸ |
| (Ω) | After 1000 hours | 5 × 10⁸ | 6 × 10⁸ |
| Corrosion | After 500 hours | Pitting | Pitting |
| Test | | corrosion | corrosion |
| | | occurred | occurred |
| | After 1000 hours | Corrosion | Pitting |
| | | occurred | corrosion occurred |

It will be noted from Table 1-1 and Table 1-2 that Examples 1 to 4, using the low Tg acrylic resin A or B, suppressed poor soldering, and also suppressed reliability deterioration and the occurrence of corrosion after placing a load of a severe cool and hot cycle from −40° C. to 125° C., that is, these examples had superior performance to Comparative Example 1 as a conventional solder paste, or Comparative Example 2 using the acrylic resin E having a Tg of −50° C. or above. It will also be noted that approximately the same performance as Example 1 or Example 2 can be obtained even when the solid content is low (Example 3), and when it is in the paste state (Example 4).

### Examples 5 to 8, and Comparative Examples 3 and 4

At least one of the acrylic resins C, D and F, which were obtained in the abovementioned manufacturing examples, hydrogenated rosin and acrylated rosin as a base resin; at least one of diphenyl acetic acid, adipic acid and monoethylamine hydrochloride as an activating agent; cured castor oil as a thixotropic agent; and butyl carbitol as a solvent, were mixed in the blending composition shown in Table 2-1 and Table 2-2, and then dissolved and dispersed by uniformly and sufficiently applying heat, thereby obtaining individual fluxes.

Subsequently, each of the obtained fluxes and lead-free solder alloy powder (38 μm to 25 μm in particle size) composed of Sn—Ag—Cu alloy (Sn:Ag:Cu=96.5:3.0:0.5 (weight ratio)) were mixed at the ratio of flux:solder alloy powder=12:88 (weight ratio), thereby obtaining individual solder paste compositions.

The obtained respective solder paste compositions were used to make solder ball test, crack test, insulation resistance test and corrosion test. The results are shown in Table 2-1 and Table 2-2.

TABLE 2-1

| | | Example | | | |
|---|---|---|---|---|---|
| | | 5 | 6 | 7 | 8 |
| Flux | Acrylic resin C | 65.0 | 40.0 | — | — |
| composition | Tg: −70° C. | | | | |
| (% by weight) | Acid value: 50 mgKOH/g | | | | |
| | Mw: about8000 | | | | |
| | Acrylic resin D | — | — | 40.0 | 67.0 |
| | Tg: −54° C. | | | | |
| | Acid value: 85 mgKOH/g | | | | |
| | Mw: about5000 | | | | |
| | Acrylic resin F | — | — | — | — |
| | Tg: −46° C. | | | | |
| | Acid value: 54 mgKOH/g | | | | |
| | Mw: about8500 | | | | |
| | Hydrogenated rosin | — | 25.0 | 10.0 | — |
| | Acrylated rosin | — | — | 15.0 | — |
| | Diphenyl acetic acid | 3.0 | 3.0 | 3.0 | — |
| | Adipic acid | — | — | — | 1.0 |
| | Monoethylamine | 0.3 | 0.3 | 0.3 | 0.3 |
| | Hydrochloride | | | | |
| | Cured castor oil | 5.0 | 5.0 | 5.0 | 5.0 |
| | Butyl carbitol | 26.7 | 26.7 | 26.7 | 26.7 |
| Flux:Solder alloy powder (weight | | 12:88 | 12:88 | 12:88 | 12:88 |
| ratio) | | | | | |
| Solder Ball Test (pieces/80 pads) | | 6 | 6 | 5 | 6 |
| Crack Test | | ◯ | ◯ | ◯ | ◯ |
| Insulation | Beginning | 5 × 10¹² | 8 × 10¹² | 6 × 10¹² | 4 × 10¹² |
| Resistance | After 500 hours | 8 × 10⁹ | 6 × 10⁹ | 7 × 10⁹ | 5 × 10⁹ |
| Test (Ω) | After 1000 hours | 8 × 10⁹ | 7 × 10⁹ | 7 × 10⁹ | 7 × 10⁹ |
| Corrosion Test | After 500 hours | No corrosion | No corrosion | No corrosion | No corrosion |
| | After 1000 hours | No corrosion | No corrosion | No corrosion | No corrosion |

TABLE 2-2

| | | Comparative Example | |
|---|---|---|---|
| | | 3 | 4 |
| Flux | Acrylic resin C | — | — |
| composition | Tg: −70° C. | | |
| (% by weight) | Acid value: 50 mgKOH/g | | |
| | Mw: about8000 | | |
| | Acrylic resin D | — | — |
| | Tg: −54° C. | | |
| | Acid value: 85 mgKOH/g | | |
| | Mw: about5000 | | |
| | Acrylic resin F | — | 65.0 |
| | Tg: −46° C. | | |
| | Acid value: 54 mgKOH/g | | |
| | Mw: about8500 | | |
| | Hydrogenated rosin | 65.0 | — |
| | Acrylated rosin | — | — |
| | Diphenyl acetic acid | 3.0 | 3.0 |
| | Adipic acid | — | — |
| | Monoethylamine | 0.3 | 0.3 |
| | Hydrochloride | | |
| | Cured castor oil | 5.0 | 5.0 |
| | Butyl carbitol | 26.7 | 26.7 |
| Flux:Solder alloy powder(weight ratio) | | 12:88 | 12:88 |
| Solder Ball Test(pieces/80pads) | | 5 | 6 |
| Crack Test | | X | Δ |
| Insulation | Beginning | 4 × 10¹² | 5 × 10¹² |
| Resistance Test | After 500 hours | 6 × 10⁷ | 5 × 10⁷ |
| (Ω) | After 1000 hours | 8 × 10⁶ | 5 × 10⁷ |
| Corrosion Test | After 500 hours | Pitting | Pitting |
| | | corrosions | corrosions |
| | | occurred | occurred |
| | After 1000 hours | Corrosions | Pitting |
| | | occurred | corrosions |
| | | | occurred |

It will be noted from Table 2-1 and Table 2-2 that Examples 5 to 8 using the low Tg acrylic resin C or D, suppressed the occurrence of solder balls, and also suppressed reliability deterioration and the occurrence of corrosion after placing a load of a severe cool and hot cycle from −40° C. to 125° C., that is, these examples had superior performance to Comparative Example 3 as a conventional solder paste, or Comparative Example 4 using the acrylic resin F having a Tg of −50° C. or above. It will also be noted that approximately the same performance as Example 5 or Example 8 can be obtained when the hydrogenated rosin or the acrylated rosin was used together (Examples 6 and 7).

As apparent from the foregoing, the present invention can achieve excellent solderability, retain corrosion resistance and high electric insulation properties even if used under the environment subjected to low and high temperature cycle or vibration, thereby improving the reliability of the soldering portions.

While one preferred embodiment of the present invention has been described, the present invention is not limited to the above embodiment.

What is claimed is:

1. A soldering flux comprising a base resin and an activating agent, wherein, as the base resin, a thermoplastic acrylic resin having a glass transition temperature of below −50° C. is contained.

2. The soldering flux according to claim 1, wherein the content of the thermoplastic acrylic resin is 0.5 to 80% by weight to a total amount of flux.

3. The soldering flux according to claim 1, wherein the content of the activating agent is 0.1 to 20% by weight to a total amount of flux.

4. The soldering flux according to claim 1, containing, as the base resin, at least one selected from the group consisting of rosin and a derivative thereof.

5. The soldering flux according to claim 1, wherein the proportion of the thermoplastic acrylic resin having a glass transition temperature of below −50° C. in the base resin is not less than 60% by weight to a total amount of the base resin.

6. A solder paste composition comprising the soldering flux according to claim 1, and solder alloy powder.
